(19) United States
(12) Patent Application Publication
(10) Pub. No.: US 2024/0380067 A1
(43) Pub. Date: Nov. 14, 2024

(54) ENERGY STORAGE SYSTEM DEFLAGRATION AND THERMAL PROPAGATION MITIGATION

(71) Applicant: Caterpillar Inc., Peoria, IL (US)

(72) Inventors: Gregory S. Hasler, Pekin, IL (US); Gregory J. Davis, Griffin, GA (US)

(73) Assignee: Caterpillar Inc., Peoria, IL (US)

(21) Appl. No.: 18/196,623

(22) Filed: May 12, 2023

(51) Int. Cl. H01M 50/383; A62C 3/16; A62C 37/40

(52) U.S. Cl. CPC H01M 50/383; A62C 3/16; A62C 37/40

(57) ABSTRACT

An energy storage system (ESS) deflagration and thermal propagation mitigation method and corresponding systems prevent and, if necessary, suppress fires in ESS containers. The method uses a gas detection system, a smoke and temperature detection system, and a fire suppression system. The gas detection system opens a vent in response to detecting a concentration of gas that meets or exceeds a threshold concentration. If needed after venting the container, the smoke and temperature detection system closes the vent and activates the fire suppression system in response to detecting both the presence of smoke and a temperature that meets or exceeds a threshold temperature.

### TECHNICAL FIELD

The present disclosure relates to a fire prevention system, and more particularly, to a fire prevention and suppression system which can be used in an energy storage system (ESS), such as a container that houses batteries.

### BACKGROUND

An ESS refers to a shipping container or other such container adapted to house racks of batteries that can be charged and discharged as needed. In some example applications, an ESS can be used to store renewable energy (e.g., solar energy or wind energy). In other example applications, an ESS can provide power to remote off-grid construction sites and mines.

Currently, many ESS are used to house lithium-ion batteries, which advantageously have a high storage capacity per unit volume, do not lose stored electricity due to self-discharge, and do not have a “memory effect” in which the capacity of the batteries is reduced when cycled without being fully discharged. ESS can be configured by stacking battery modules in a container. Multiple battery modules can be stacked in electrically connected battery racks, which can be charged and discharged through appropriate electronics housed within the ESS.

Lithium-ion batteries can potentially overheat, leading to fires. Therefore, ESS are typically equipped with fire suppression systems. An example of an ESS fire suppression system is described in U.S. Pat. No. 10,933,263 (hereinafter, the “263” reference). The '263 reference describes a fire control system that is equipped with a heating, ventilation, and air conditioning (HVAC) system and a fire extinguisher. The system includes a smoke detector, a heat detector, a flame detector in the ESS container, a duct smoke detector in a duct of the HVAC system, and a fire extinguisher which is operated when all of the smoke detector, the heat detector, and the flame detector detect a fire, when the duct smoke detector detects a fire, or when a manipulation button is operated.

However, the system described in the '263 reference has several shortcomings. For example, the disclosed system is not configured to prevent fire conditions before they occur. Some batteries discharge flammable gasses during or after failure. Lithium-ion batteries can discharge hydrogen gas which is highly flammable. By failing to detect and address discharged gasses, an early detection opportunity is missed, and dangerous conditions may be allowed to develop prior to activation of the system.

Examples of the present disclosure are directed toward overcoming the deficiencies described above.

### SUMMARY

According to a first aspect, an example method includes receiving first information from a first sensor, the first information indicative of a concentration of a gas present within a container; determining, based on the first information, that the concentration is greater than or equal to a concentration threshold; and opening, based on determining that the concentration is greater than or equal to the concentration threshold, a vent in order to release the gas from the container.

The method can further include receiving, while the vent is in an open position, a first one of second information from a second sensor or third information from a third sensor. The second information is indicative of smoke present within the container, and the third information is indicative of a temperature within the container that is greater than or equal to a threshold temperature. A fire suppression system can optionally be maintained in a deactivated state after receiving the first one of the second information or the third information.

The method can further include receiving a second one of the second information or the third information; closing, based on the receiving the second one of the second information or the third information, the vent; and activating, based on the receiving the second one of the second information or the third information, the fire suppression system within the container.

The method can further include receiving, while the vent is in an open position, a first one of second information from a second sensor or third information from a third sensor. The second information is indicative of smoke present within the container, and the third information is indicative of a temperature within the container that is greater than or equal to a threshold temperature. A fire suppression system can optionally be maintained in a deactivated state after receiving the first one of the second information or the third information.

According to a further aspect, a system is provided, comprising a gas detection system and a smoke and temperature detection system. The gas detection system can comprise a gas detection system controller and a gas sensor. The gas detection system controller can be configured to detect, via the gas sensor, a concentration of a gas within a container, in order to determine whether the concentration meets or exceeds a threshold concentration. The gas detection system controller can be configured to open a vent in response to detecting that the concentration meets or exceeds the threshold concentration.

The smoke and temperature detection system can comprise a smoke and temperature detection system controller, a smoke detector, and a temperature sensor. The smoke and temperature detection system controller can be configured to detect, via the smoke detector, a presence of smoke within the container. The smoke and temperature detection system controller can be further configured to detect, via the temperature sensor, a temperature that meets or exceeds a threshold temperature. The smoke and temperature detection system controller can be configured to close the vent and activate a fire suppression system within the container in response to detecting both the presence of smoke and the temperature that meets or exceeds the threshold temperature.

According to a further aspect, a container is provided, comprising at least one battery within an interior of the container; an input from which the at least one battery can be charged; an output from which the at least one battery can be discharged; a ventilation system; and a fire hazard detection and suppression system.

The fire hazard detection and suppression system can comprise a gas detection system and a smoke and temperature detection system. The gas detection system can be configured to detect whether a concentration of a gas meets or exceeds a threshold concentration, and the gas detection system can be configured to activate the ventilation system and terminate charge and discharge of the at least one battery in response to detecting that the concentration of the gas meets or exceeds the threshold concentration. The smoke and temperature detection system can be configured to activate a fire suppression system within the container, in response to detecting, subsequent to the detecting that the concentration of the gas meets or exceeds the threshold concentration, a presence of smoke and a temperature that meets or exceeds a threshold temperature.

### BRIEF DESCRIPTION OF THE FIGURES

FIG. 1 illustrates a first perspective view of an example ESS comprising a container and an HVAC system, according to an example of the present disclosure.

FIG. 2 illustrates a side elevation view of the ESS introduced in FIG. 1, according to an example of the present disclosure.

FIG. 3 illustrates example ESS components that can be housed within the container introduced in FIG. 1, according to an example of the present disclosure.

FIG. 4 illustrates example systems that can be positioned within the ESS introduced in FIG. 1, including a gas detection system, a smoke and temperature detection system, and a fire suppression system, according to an example of the present disclosure.

FIG. 5 illustrates an example gas detection system that can be positioned within the ESS as illustrated in FIG. 4, according to an example of the present disclosure.

FIG. 6 illustrates an example combined smoke and temperature detection system and fire suppression system that can be positioned within the ESS as illustrated in FIG. 4, according to an example of the present disclosure.

FIG. 7 illustrates an example energy storage system deflagration and thermal propagation mitigation method, according to an example of the present disclosure.

FIG. 8 illustrates an example schematic arrangement of a fire hazard detection and suppression system, according to an example of the present disclosure.

### DETAILED DESCRIPTION

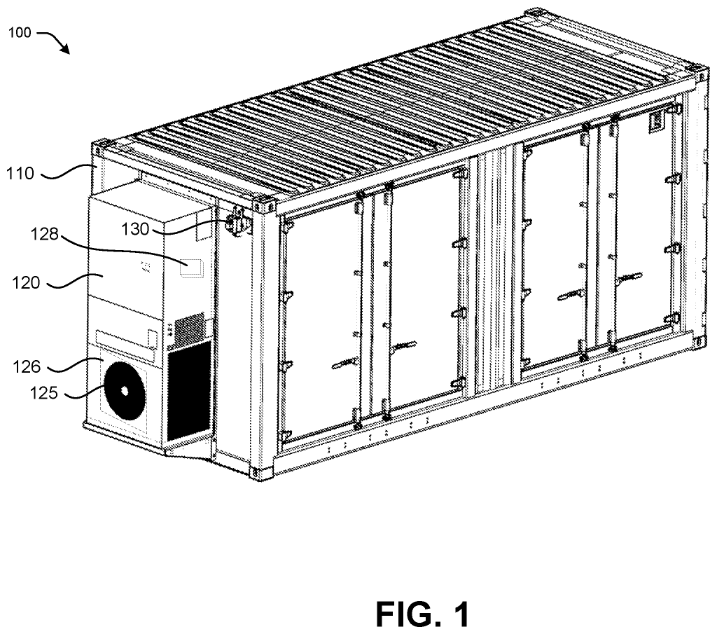

FIG. 1 illustrates a first perspective view of an example an ESS 100 comprising a container 110 and an HVAC system 120, according to an example of the present disclosure. In some embodiments, the example container 110 can comprise, e.g., a twenty (20) foot long International Standards Organization (ISO) container that is in a standard form that is efficiently transported by ship, train, and/or truck. In other embodiments, the container 110 can be of other dimensions and/or shapes as desired and to meet the needs of specific applications. The container 110 can comprise various access openings and doors according to the example configuration illustrated in FIG. 1, or according to any other desired access configurations.

The HVAC system 120 can be mounted on the exterior of the container 110. The HVAC system 120 can be adapted to circulate air through the container 110 via air duct openings in the container 110 which are not visible in FIG. 1. The HVAC system 120 can condition the circulated air, e.g., by heating or cooling the circulated air. In general, the HVAC system 120 can recirculate air within the container 110, so that the air inside the container 110 is not exchanged with air from outside the container 110.

The HVAC system 120 can include an opening 125 adapted to introduce outside air into the container 110. The opening 125 can be opened and closed via a vent 126 that is controllable via an HVAC system controller 128 (the vent 126 and the HVAC system controller 128 are shown in dashed lines to reflect that they are inside the HVAC system 120 in the illustrated embodiment). In some embodiments, the vent 126 can comprise an “economizer damper” of the HVAC system 120, which can be operated to reduce a heating and/or cooling load on the HVAC system 120. Embodiments of this disclosure can make a further use of the economizer damper, namely, operating the economizer damper to vent gas detected within the container 110, as described herein.

One or more alarm devices, such as an example alarm device 130, can be mounted on the exterior of the container 110. The alarm device 130 can comprise light and/or sound elements which provide visual and/or audible notifications related to conditions inside the container 110. The alarm device 130 can optionally have several different alarm modes, e.g., differently colored lights and/or different sounds that correspond to different conditions inside the container 110. For example, a gas detection alarm mode of the alarm device 130 can be activated in response to detecting a gas inside the container 110, and smoke and/or fire alarm modes of the alarm device 130 can be activated in response to detecting smoke and/or heat indicative of a potential fire inside the container 110.

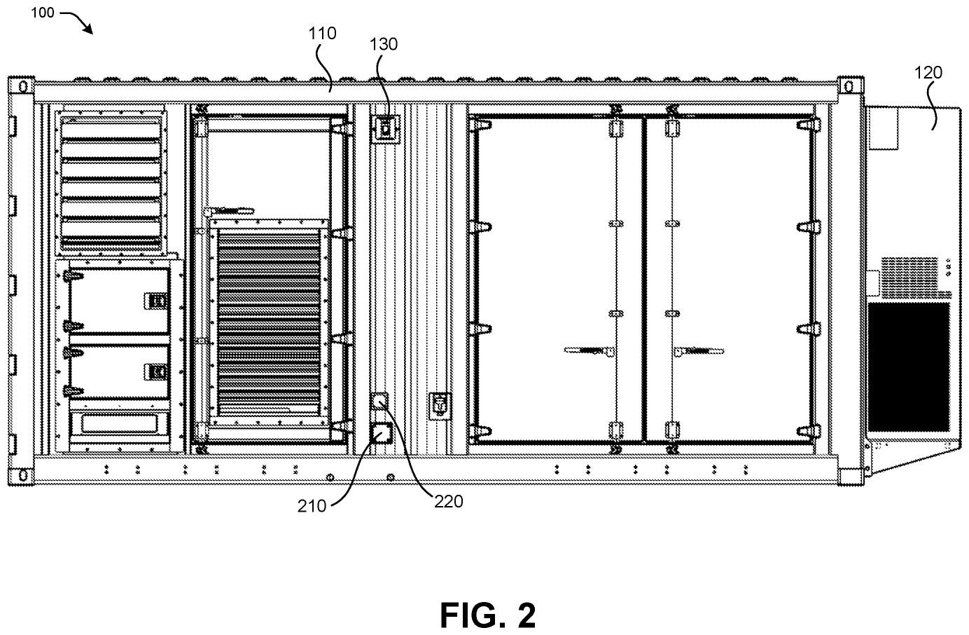

FIG. 2 illustrates a side elevation view of the ESS 100 introduced in FIG. 1, according to an example of the present disclosure. FIG. 2 illustrates the container 110, another example alarm device 130, the HVAC system 120, various access doors and panels, an access opening 210 for an alternating current (AC) input, and an access opening 220 for an AC output. Batteries inside the container 110 can optionally be charged via a first power cable coupled with the ESS 100 via the AC input access opening 210. The batteries inside the container 110 can optionally be discharged via a second power cable coupled with the ESS 100 via the AC output access opening 220. The ESS 100 can be used to provide AC electrical power to any desired application via the second power cable.

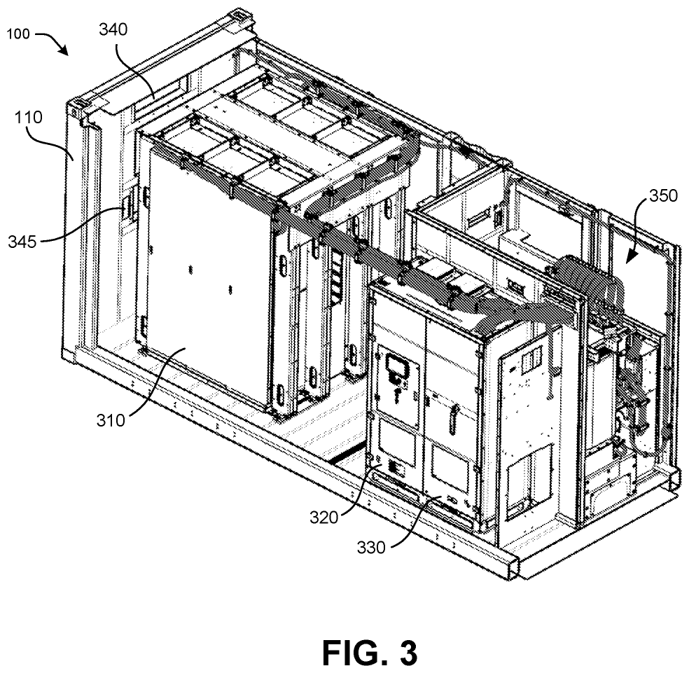

FIG. 3 illustrates example ESS components that can be housed within the container 110 introduced in FIG. 1, according to an example of the present disclosure. FIG. 3 illustrates a battery housing 310, an inverter 320, a power converter 330, HVAC openings 340, 345, and a separated compartment 350 in the container 110.

The battery housing 310 can house multiple stacks of lithium-ion batteries, or any other desired battery type. The battery housing 310 can be configured to allow air flow between the multiple stacks. For example, air can exit the HVAC opening 340, and can return to the HVAC system 120 via the HVAC opening 345, after circulating through the battery housing 310. Air can also optionally circulate in an opposite direction, e.g., by exiting HVAC opening 345, circulating through the battery housing 310, and returning to the HVAC system 120 via the HVAC opening 340.

The power converter 330 can be configured to receive an AC input, e.g., from an external generator, power grid, or other electrical power source, and use the AC input to charge the batteries in the battery housing 310. The inverter 320 can be configured to receive a direct current (DC) output of the batteries in the battery housing 310, convert the DC output into an AC output, and supply the AC output via an output cable to any application(s) powered by the ESS 100.

The separated compartment 350 can be a compartment that is partitioned from a larger enclosed volume of the container 110, e.g., by walls or panels. The separated compartment 350 can but need not be sealed in a manner that prevents air circulation between the separated compartment 350 and the larger enclosed volume of the container 110. The separated compartment 350 can optionally house the power converter 330, the inverter 320, or any other additional electronics associated with the ESS 100. In embodiments comprising a separated compartment 350, fire suppressant units can be distributed to include a fire suppressant unit for the separated compartment 350, as described herein.

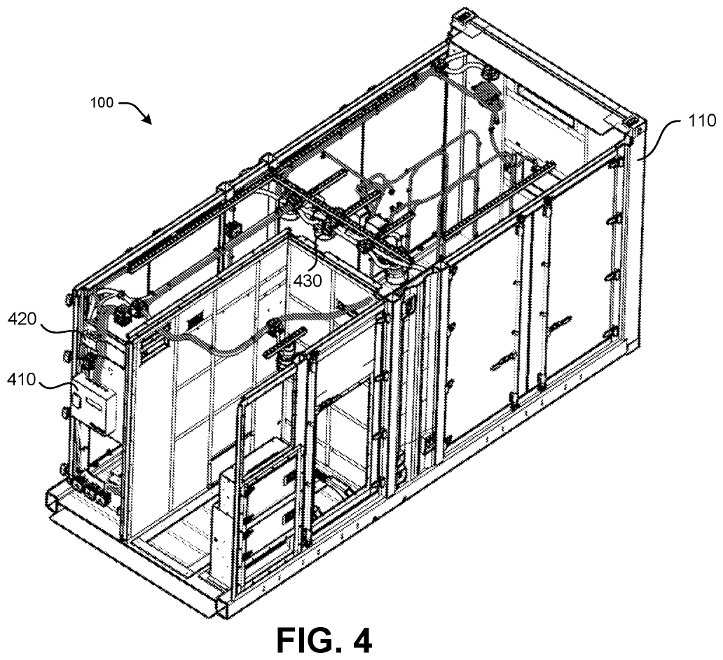

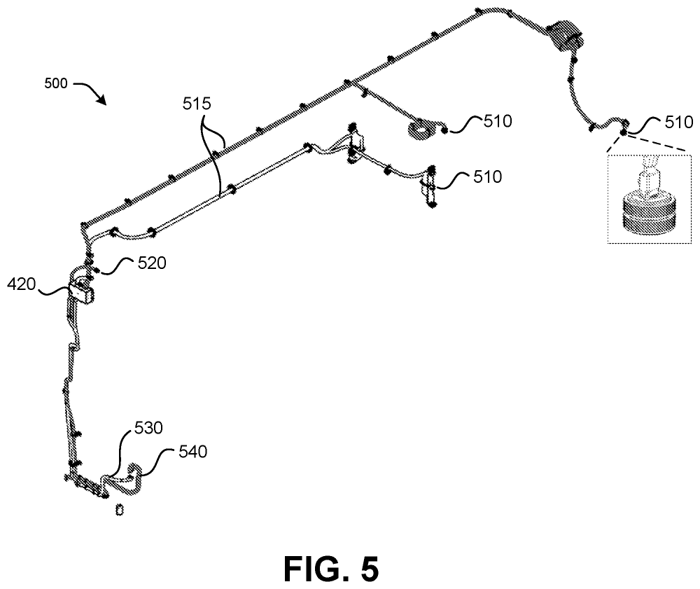

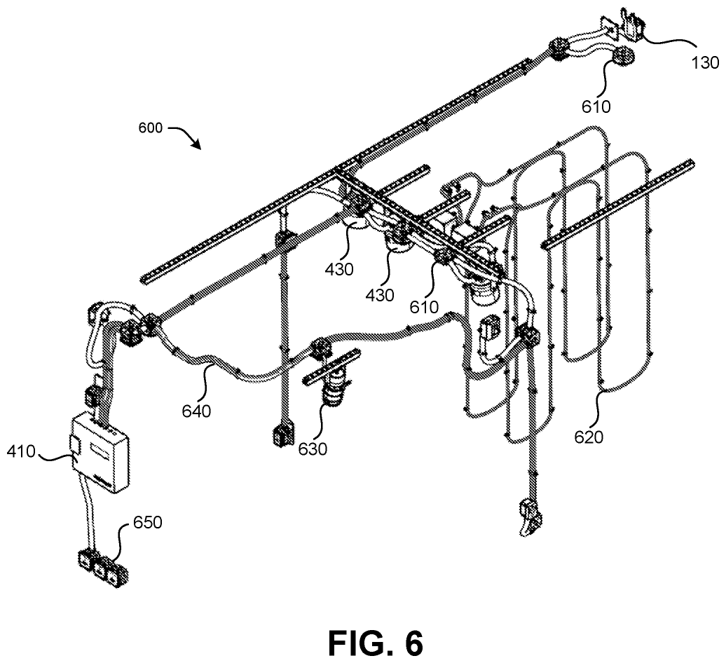

FIG. 4 illustrates example systems that can be positioned within the ESS 100, including a gas detection system comprising a gas detection system controller 420, a smoke and temperature detection system comprising a smoke and temperature detection system controller 410, and a fire suppression system comprising fire suppressant units 430, all within the container 110 introduced in FIG. 1. Further aspects of the gas detection system, smoke and temperature detection system, and fire suppression system are described in detail with reference to FIGS. 5 and 6.

FIG. 4 illustrates one example arrangement of components of the gas detection system, smoke and temperature detection system, and fire suppression system. It will be understood that other arrangements can be made to suit other container volumes and layouts. For instance, FIG. 4 illustrates an arrangement of fire suppressant units 430 that positions a fire suppressant unit 430 in the separated compartment 350 and also positions fire suppressant units 430 within the larger unseparated volume of the container 110.

FIG. 5 illustrates an example gas detection system 500 that can be positioned within the ESS 100 as illustrated in FIG. 4, according to an example of the present disclosure. The gas detection system 500 comprises one or more gas sensors 510 coupled with a gas detection system controller 420 via connection lines 515, a gas sensor 520 that serves as a reference sensor, an output connection line 530 that couples the gas detection system controller 420 with a smoke and temperature detection system controller 410, and an output connection line 540 that couples the gas detection system controller 420 with an HVAC system 120 controller.

In an example embodiment, the gas detection system controller 420 can be configured to detect, via the gas sensors 510, a concentration of a flammable gas such as hydrogen, or any other gas of concern, within the container 110, in order to determine whether the concentration meets or exceeds a threshold concentration. The gas detection system controller 420 can optionally be configured to detect concentrations of multiple different gasses, and to further process one or more of the detected gas concentrations to threshold concentrations. The gas detection system controller 420 can be configured to open a vent 126, e.g., the economizer damper of the HVAC system 120, in response to detecting that a concentration meets or exceeds a threshold concentration. The gas detection system controller 420 can output a signal via the output connection line 540 that couples the gas detection system controller 420 with an HVAC system 120 (optionally the HVAC system controller 128), and the signal can instruct the HVAC system controller 128 to open the economizer damper. The signal can optionally furthermore instruct the HVAC system 120 to operate a fan to accelerate venting of the container 110.

The gas detection system controller 420 can also be configured to notify the smoke and temperature detection system controller 410 in response to detecting that the gas concentration meets or exceeds the threshold concentration. The gas detection system controller 420 can output a signal via the output connection line 530 that couples the gas detection system controller 420 with the smoke and temperature detection system controller 410, and the signal can notify the smoke and temperature detection system controller 410 of the gas detection event. The output signal can comprise, e.g., a phase two relay logic signal.

In some embodiments, the smoke and temperature detection system controller 410 can be a combined controller that is configured to control the alarms 130, the fire suppression system, the HVAC system 120 or components thereof, and charge/discharge functions of the ESS 100 such as the power converter 330 and inverter 320. By notifying the smoke and temperature detection system controller 410 of the gas detection event, the gas detection system controller 420 can initiate activation of an alarm mode of the alarms 130 in response to the gas detection event, and to terminate battery charge and/or discharge functions that charge or discharge batteries within the container 110.

The gas detection system controller 420 can optionally be configured to close the vent 126 after elapse of a predetermined period of time, such as fifteen minutes or any other time interval, without occurrence of a smoke or excess temperature detection event. The gas detection system controller 420 can output a signal via the output connection line 540 that couples the gas detection system controller 420 with an HVAC system 120 controller, and the signal can instruct the HVAC system 120 to close the economizer damper. Embodiments can but need not necessarily also reactivate ESS operations by reactivating charge and discharge functions. For safety, embodiments can avoid reactivating charge and discharge functions until these functions are manually reset.

In some embodiments, at least one of the gas sensors 510 can be positioned within an air intake of a container ventilation system, e.g., within an intake to the HVAC system 120, such as the intake 345 illustrated in FIG. 3. In some embodiments, the gas detection system controller 420 can use a reference sensor 520 along with the gas sensors 510. The reference sensor 520 can reduce “false positive” gas detection events. The reference sensor 520 can be positioned at a different location than location(s) of the gas sensors 510 within the container 110. The gas detection system controller 420 can be configured to determine that a gas concentration, e.g., a concentration of a flammable gas of concern such as hydrogen, is greater than or equal to a concentration threshold based on reference information received from the reference sensor. For example, the gas detection system controller 420 can be configured to determine that a gas concentration is greater than or equal to a concentration threshold when a gas sensor 510 has a reading that meets or exceeds the concentration threshold while the reference sensor 520 does not have a reading that meets or exceeds the concentration threshold.

FIG. 6 illustrates an example combined smoke and temperature detection system and fire suppression system 600 that can be positioned within the ESS 100 as illustrated in FIG. 4, according to an example of the present disclosure. The combined system 600 includes a smoke and temperature detection system controller 410 which can be configured to detect smoke and excess temperature within the container 110 and activate the fire suppression system, as well as perform other functions described herein.

The smoke and temperature detection system controller 410 can be coupled via various connection cables 640 to smoke detectors 610 and a temperature sensor 620. The smoke and temperature detection system controller 410 can be configured to detect, via the smoke detectors 610, a presence of smoke within the container 110. The smoke and temperature detection system controller 410 can also configured to detect, via the temperature sensor 620, a temperature that meets or exceeds a threshold temperature. The smoke and temperature detection system controller 410 can be configured to close the vent 126 (e.g., the economizer damper) and activate the fire suppression system (e.g., the fire suppression units 430) within the container 110 in response to detecting both the presence of smoke and the temperature that meets or exceeds the threshold temperature.

The smoke and temperature detection system controller 410 can be configured to detect, via the smoke detectors 610, a presence of smoke within the container 110 by receiving a signal or other information from the smoke detectors 610 via the connection cables 640. In some embodiments, the smoke detectors 610 can comprise microprocessors that are configured to output detection signals to the smoke and temperature detection system controller 410 in response to smoke detection events. The smoke and temperature detection system controller 410 can receive a smoke detection signal from any of the multiple smoke detectors 610 that are positioned at multiple locations within the container 110.

The smoke and temperature detection system controller 410 can be configured to detect, via the temperature sensor 620, a temperature that meets or exceeds a threshold temperature by detecting a failure of a temperature sensor 620 electrical circuit adapted conduct an electrical current at temperatures below the threshold temperature and adapted to fail, e.g., by melting, at temperatures substantially at or above the threshold temperature. For example, the smoke and temperature detection system controller 410 can periodically or continuously apply a detection voltage across the temperature sensor 620 electrical circuit in order to determine, from a change in the detection voltage, whether the circuit has failed. In some embodiments, the threshold temperature can be, e.g., 60-180 degrees Celsius.

To close the vent 126, the smoke and temperature detection system controller 410 can be configured to output a signal via the output connections 650. The output connections 650 can comprise an output connection to the HVAC system 120, and the HVAC system 120 can close the vent 126 in response to the signal from the smoke and temperature detection system controller 410.

To activate the fire suppression system (e.g., the fire suppression units 430) within the container 110, the smoke and temperature detection system controller 410 can be configured to switch an electrical circuit, e.g., a 120 Volt circuit, coupled via connection cables 640 with the fire suppressant units 430 in order to supply power to the fire suppressant units 430. The fire suppressant units 430 can be electrically activatable fire suppressant units of a fire suppression system. In some embodiments, the electrically activatable fire suppressant units 430 can be adapted to spray an ionized potassium fire suppressant when activated. By attaching multiple fire suppressant units 430 to a same electrical circuit that is activatable by the smoke and temperature detection system controller 410, the operation of the fire suppressant units 430 can be synchronized. The number and distribution of the multiple fire suppressant units 430 can depend on the dimensions and configuration of the interior of the container 110.

In some embodiments, a fire suppressant unit 630 can be positioned in the separated compartment 350 of the container 110, illustrated in FIG. 3. The fire suppressant unit 630 can optionally be a different type of fire suppressant unit than the fire suppressant units 430. For example, the fire suppressant unit 630 can be a “thermal generator” which self-activates at a threshold temperature, e.g., 70-150 degrees Celsius, while the fire suppressant units 430 are configured as electrical generators activated by the smoke and temperature detection system controller 410.

The smoke and temperature detection system controller 410 can optionally be configured to activate the alarm(s) 130 in a gas detection alarm mode in response to a gas detection by the gas detection system 500. The smoke and temperature detection system controller 410 can also be configured to activate the alarm(s) 130 in a first alarm mode, different from the gas detection alarm mode, in response to detecting either a presence of smoke or a temperature that meets or exceeds a threshold temperature in the container 110. The first alarm mode can comprise, e.g., a white or other first color alarm light. The smoke and temperature detection system controller 410 can be configured to activate the alarm(s) 130 in a second alarm mode, different from the gas detection and first alarm modes, in response to detecting both the presence of smoke and the temperature that meets or exceeds the threshold temperature the container 110. The second alarm mode can comprise, e.g., a blue or other second color alarm light, operated in a flashing (strobe) mode and accompanied by an audible sound such as a horn.

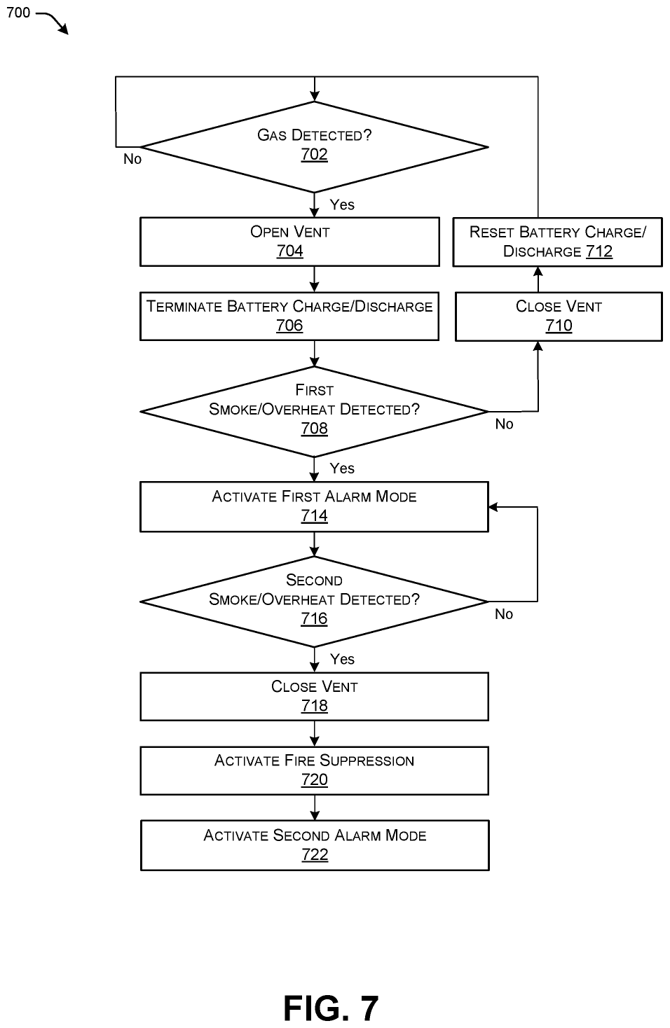

FIG. 7 illustrates an example ESS deflagration and thermal propagation mitigation method 700, according to an example of the present disclosure. In some embodiments, the illustrated operations can be carried out by one or more controllers within an ESS 100. For example, in the examples illustrated in FIGS. 1-6, the illustrated operations 702, 704, 706, 710 and 712 can be performed using a first controller, e.g., the gas detection system controller 420, optionally in cooperation with an HVAC system 120 controller and/or the smoke and temperature detection system controller 410. The operations 708, 714, 716, 718, 720, and 722 can be performed using a second controller, e.g., smoke and temperature detection system controller 410, which can also optionally operate in cooperation with the other controllers and components described herein. Although one or more steps of the method 700 (and in some examples, all steps of the method 700) may be performed by a single controller (e.g., the gas detection system controller 420), example steps of the method 700 will be described below as being performed by various controllers working in cooperation.

At 702, the first controller (the gas detection system controller 420) can determine whether a flammable gas of concern, e.g., hydrogen, is detected within the container 110. In an embodiment, the first controller can be configured to receive first information from a first sensor, e.g., a gas sensor 510, the first information indicative of a concentration of a gas present within a container 110. At least one of the gas sensors 510 can be positioned within an air intake 345 of a container ventilation system such as HVAC system 120. The first controller can be configured to determine, based on the first information, that the concentration is greater than or equal to a concentration threshold. In some embodiments, determining that the concentration is greater than or equal to the concentration threshold can be further based on reference information received from a reference sensor 520, wherein the first sensor 519 and the reference sensor 520 are positioned at different locations within the container 110.

At 704, the first controller (the gas detection system controller 420) can open a vent 126 of the container 110 in order to vent the flammable gas. For example, the first controller can be configured to open, based on determining that the concentration is greater than or equal to the concentration threshold, an HVAC system 120 vent 126 such as an economizer damper and activate a HVAC system 120 fan in order to disperse the flammable gas from the container 110. The fire suppression system need not be activated within the container 110 in response to determining that the concentration is greater than or equal to the concentration threshold. Activating the fire suppression system can be deferred until after positive detection results pursuant to operations 708 and/or 716.

At 706, the first controller (the gas detection system controller 420) can terminate battery charge and/or discharge functions of the ESS 100. For example, the first controller can terminate at least one of a charge function or a discharge function of one or more lithium-ion batteries based on determining that the concentration is greater than or equal to the concentration threshold. Terminating the charge function can comprise terminating operation of a power converter 330 and terminating the discharge function can comprise terminating operation of an inverter 320. In some embodiments, the first controller can furthermore be configured to notify the smoke and temperature detection system controller 410 in response to detecting that the concentration meets or exceeds the threshold concentration.

At 708, the second controller (the smoke and temperature detection system controller 410) can determine whether a first one of smoke and/or overheat is detected. If no, then after elapse of a predetermined period of time, such as 5-30 minutes without occurrence smoke and/or overheat detection, the first controller and/or the second controller can be configured to close the vent at operation 710 and optionally reset battery charge/discharge functions at operation 712. In some embodiments, a manual reset can be performed at 712 to ensure safety of the container 110. After safe conditions have been restored, the first controller can return to normal gas monitoring operations, proceeding to operation 702 if a further detection is made.

If yes at 708 then either smoke or overheat is detected by the second controller. For example, the second controller (the smoke and temperature detection system controller 410) can receive, after the vent 126 was opened pursuant to a gas detection at operation 704, one of second information from a second sensor, e.g., a smoke detector 610, or third information from a third sensor, e.g., a temperature sensor 620. The second information is indicative of smoke present within the container 110 and can be received from any of multiple smoke detectors 610 that are positioned at multiple locations within the container 110. The third information is indicative of a temperature within the container 110 meeting or exceeding a threshold temperature. Receiving the third information can comprise detecting a failure of an electrical circuit adapted conduct an electrical current at temperatures below the threshold temperature and adapted to fail at temperatures substantially at or above the threshold temperature.

If yes at 708, then at 714 the second controller (the smoke and temperature detection system controller 410) can activate a first alarm mode of the alarm(s) 130. For example, the second controller can activate, based on the receiving one of the second information or the third information, a first alarm mode of an alarm device 130 positioned external to the container 110. However, the second controller need not yet activate the fire suppression system in response to the receiving one of the second information or the third information, as embodiments can activate the fire suppression system after both of the second information and the third information are received.

At 716, the second controller (the smoke and temperature detection system controller 410) can determine whether a second one of smoke and/or overheat is detected. If no, then the first alarm mode can remain active according to operation 714, and the second controller can continue to monitor for the second one of smoke and/or overheat, however, the fire suppression system need not be activated. If yes at 716, then the second controller can receive, after opening of the vent 126 at operation 704 and after the receiving one of the second information or the third information at operation 708, the other of the second information or the third information. If smoke was detected at 708, then the second controller can receive overheat/high temperature detection information at 716. If overheat/high temperature was detected at 708, then the second controller can receive smoke detection information at 716.

At 718, the second controller (the smoke and temperature detection system controller 410) can close the vent 126 of the container 110 in order to at least partially seal the container 110 from the exterior environment. For example, the second controller can close, based on the receiving the other of the second information or the third information, the vent 126. The second controller can be configured to close, based on determining that the second one of smoke and/or overheat is detected, an HVAC system 120 vent 126 such as an economizer damper.

At 720, the second controller (the smoke and temperature detection system controller 410) can activate a fire suppression system. For example, the second controller can activate, based on the receiving the other of the second information or the third information, the fire suppression system within the container 110. The fire suppression system can comprise one or more electrically activatable fire suppressant units 430 and activating the fire suppression system can comprise switching an electrical circuit coupled to the electrically activatable fire suppressant units 430 in order to supply electrical power to the electrically activatable fire suppressant units 430.

At 722, the second controller (the smoke and temperature detection system controller 410) can activate a second alarm mode. For example, the second controller can activate, based on the receiving the other of the second information or the third information, a second alarm mode of the alarm device 130. After 722, the container 110 is sealed, the fire suppression system has been activated, and the alarm has been activated. After a period of time such as 10-48 hours, the container 110 may be considered safe for inspection.

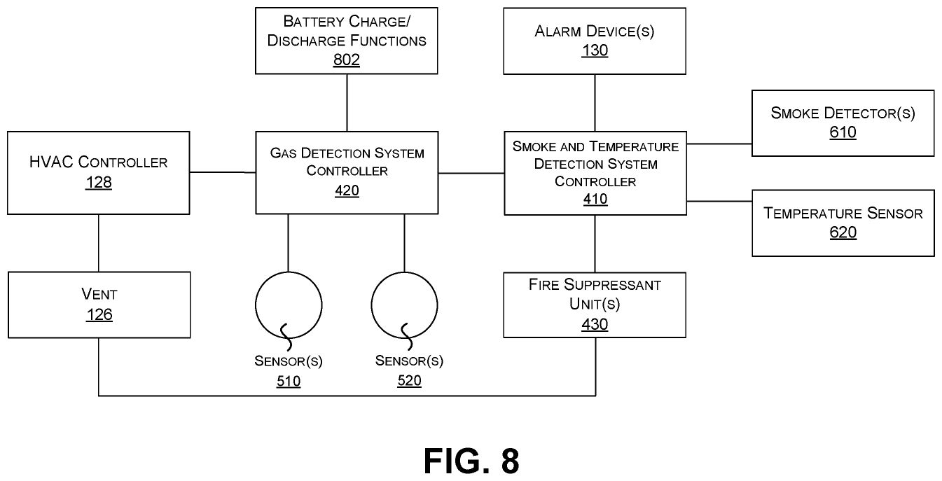

FIG. 8 illustrates an example schematic arrangement of a fire hazard detection and suppression system, according to an example of the present disclosure. FIG. 8 includes the HVAC controller 128, vent 126, gas detection system controller 420, sensor(s) 510, sensor(s) 520, alarm device(s) 130, smoke and temperature detection system controller 410, fire suppressant unit(s) 430, smoke detector(s) 610, and temperature sensor 620, introduced in FIGS. 1-6. FIG. 8 also includes battery charge/discharge functions 802 which can be implemented for example by the inverter 320 and the power converter 330 illustrated in FIG. 3.

In an example according to FIG. 8, the gas detection system controller 420 can receive sensor information from the sensor(s) 510 and the reference sensor(s) 520. In response to a gas detection event wherein the gas detection system controller 420 determines that a concentration of flammable gas is greater than or equal to a concentration threshold, the gas detection system controller 420 can communicate with the HVAC controller 128 and/or the vent 126, in order to open the vent 126. The gas detection system controller 420 can also communicate with the battery charge/discharge functions 802 in order to stop the battery charge/discharge functions 802. Furthermore, the gas detection system controller 420 can also communicate with the smoke and temperature detection system controller 410 and/or the alarm device(s) 130 in order to activate a gas detection alarm mode.

If a period of time, e.g., fifteen minutes, or any other desired time period, elapses without a further detection of smoke and/or excessive heat, the temperature detection system controller 410 or the gas detection system controller 420 can optionally close the vent 126 via a communication to the HVAC controller 128 and/or the vent 126.

In response to a first one of a smoke detection via the smoke detector(s) 610 or an excess temperature detection via the temperature sensor 620, the smoke and temperature detection system controller 410 can optionally maintain the fire suppression unit(s) 430 in a deactivated state. The smoke and temperature detection system controller 410 can optionally activate a preliminary fire alarm mode via the alarm device(s) 130. The preliminary fire alarm mode can optionally be selected from different preliminary fire alarm options in order to distinguish between smoke and excess temperature/deflagration.

In response to a second one of a smoke detection via the smoke detector(s) 610 or an excess temperature detection via the temperature sensor 620, so that both smoke and excess temperature/deflagration are detected, the smoke and temperature detection system controller 410 can communicate with the HVAC controller 128 and/or the vent 126, in order to close the vent 126, and the smoke and temperature detection system controller 410 can activate the fire suppression unit(s) 430. The smoke and temperature detection system controller 410 can optionally furthermore activate a fire alarm mode via the alarm device(s) 130, wherein the fire alarm mode indicates that smoke and excess temperature were detected and the fire suppression unit(s) 430 were activated.

### Industrial Applicability

The present disclosure describes systems and methods for preventing and responding to gas detection events, smoke, and overheat/deflagration in an ESS. An example ESS can comprise a container equipped with lithium-ion batteries, an AC input from which the batteries can be charged; an AC output from which batteries can be discharged; a ventilation system; and a fire hazard detection and suppression system. The fire hazard detection and suppression system can comprise a gas detection system such as illustrated in FIG. 5, and a smoke/temperature detection system that can activate a fire suppression system, such as illustrated in FIG. 6.

The gas detection system can be configured to detect whether a concentration of a flammable gas such as hydrogen meets or exceeds a threshold concentration. The gas detection system can be configured to activate the ventilation system, e.g., by opening an economizer damper thereof, and terminate charge and discharge of batteries in response to detecting that the concentration of the flammable gas meets or exceeds the threshold concentration.

The smoke and temperature detection system can be configured to activate the fire suppression system within the container 110 in response to detecting, subsequent to the detecting that the concentration of the flammable gas meets or exceeds the threshold concentration, both a presence of smoke and a temperature that meets or exceeds a threshold temperature. The fire suppression system can comprise one or more electrically activatable fire suppressant units adapted to spray an ionized potassium fire suppressant. The smoke and temperature detection system can be further configured to activate an alarm in response to the detecting either or both the presence of smoke and the temperature that meets or exceeds the threshold temperature.

Embodiments of this disclosure can improve upon prior systems by detecting and subsequently venting an ESS of flammable gas before smoke and/or fire are detected. Furthermore, by avoiding the activation of fire suppressant units until smoke and fire are detected, embodiments can similarly avoid potentially unnecessary activation of fire suppressant units.

What is claimed is:

1. A method, comprising:
receiving first information from a first sensor, the first information indicative of a concentration of a gas present within a container;
determining, based on the first information, that the concentration is greater than or equal to a concentration threshold;
opening, based on determining that the concentration is greater than or equal to the concentration threshold, a vent in order to release the gas from the container;
receiving, while the vent is in an open position, a first one of second information from a second sensor or third information from a third sensor, wherein:
the second information is indicative of smoke present within the container, and the third information is indicative of a temperature within the container that is greater than or equal to a threshold temperature, and
maintaining a fire suppression system in a deactivated state after receiving the first one of the second information or the third information;
receiving a second one of the second information or the third information;
closing, based on the receiving the second one of the second information or the third information, the vent; and
activating, based on the receiving the second one of the second information or the third information, the fire suppression system within the container.

2. The method of claim 1, further comprising:
activating, based on the receiving the first one of the second information or the third information, a first alarm mode of an alarm; and
activating, based on the receiving the second one of the second information or the third information, a second alarm mode of the alarm.

3. The method of claim 1, wherein:
the receiving the first information and the determining, based on the first information, that the concentration is greater than or equal to the concentration threshold are performed at least in part by a first controller, and
the receiving the first one of the second information or the third information, the receiving the second one of the second information or the third information, and the activating the fire suppression system are performed at least in part by a second controller separate from the first controller.

4. The method of claim 1, wherein one or more lithium-ion batteries are disposed within the container, and wherein the method further comprises terminating at least one of a charge function or a discharge function of the one or more lithium-ion batteries based on determining that the concentration is greater than or equal to the concentration threshold.

5. The method of claim 1, wherein the vent is closed after a predetermined period of time has elapsed without occurrence of the receiving one of the second information or the third information.

6. The method of claim 1, wherein the fire suppression system comprises one or more electrically activatable fire suppressant units, and wherein activating the fire suppression system comprises operating an electrical circuit coupled to the electrically activatable fire suppressant units to supply electrical power to the electrically activatable fire suppressant units.

7. The method of claim 1, wherein the determining that the concentration is greater than or equal to the concentration threshold is further based on reference information received from a reference sensor.

8. The method of claim 1, wherein the gas comprises hydrogen.

9. The method of claim 1, wherein receiving the third information comprises detecting a failure of an electrical circuit adapted to conduct an electrical current at temperatures below the threshold temperature and adapted to fail at temperatures substantially at or above the threshold temperature.

10. A system, comprising:
a gas detection system comprising a gas detection system controller and a gas sensor,
wherein the gas detection system controller is configured to detect, via the gas sensor, a concentration of a gas within a container, in order to determine whether the concentration meets or exceeds a threshold concentration, and
wherein the gas detection system controller is configured to open a vent in response to detecting that the concentration meets or exceeds the threshold concentration; and
a smoke and temperature detection system comprising a smoke and temperature detection system controller, a smoke detector, and a temperature sensor,
wherein the smoke and temperature detection system controller is configured to detect, via the smoke detector, a presence of smoke within the container,
wherein the smoke and temperature detection system controller is configured to detect, via the temperature sensor, a temperature that meets or exceeds a threshold temperature, and
wherein the smoke and temperature detection system controller is configured to close the vent and activate a fire suppression system within the container in response to detecting both the presence of smoke and the temperature that meets or exceeds the threshold temperature.

11. The system of claim 10, wherein the gas detection system controller is configured to notify the smoke and temperature detection system controller in response to detecting that the concentration meets or exceeds the threshold concentration.

12. The system of claim 10, further comprising an alarm coupled with the smoke and temperature detection system controller, wherein the smoke and temperature detection system controller is configured to activate the alarm in response to detecting one of the presence of smoke or the temperature that meets or exceeds the threshold temperature.

13. The system of claim 10, wherein, in response to detecting that the concentration meets or exceeds the threshold concentration, the gas detection system controller is configured to terminate a battery charge or discharge function that charges or discharges one or more batteries within the container.

14. The system of claim 10, wherein the gas comprises a flammable gas.

15. The system of claim 10, further comprising the fire suppression system, wherein the fire suppression system comprises one or more electrically activatable fire suppressant units, and wherein the smoke and temperature detection system controller is configured to activate the fire suppression system by switching an electrical circuit coupled with the one or more electrically activatable fire suppressant units in order to supply power to the electrically activatable fire suppressant units.

16. The system of claim 10, wherein the gas sensor is positioned within an air intake of a container ventilation system.

17. A container, comprising:
at least one battery within an interior of the container;
an input from which the at least one battery can be charged;
an output from which the at least one battery can be discharged;
a ventilation system; and
a fire hazard detection and suppression system, comprising:
a gas detection system configured to detect whether a concentration of a gas meets or exceeds a threshold concentration, wherein the gas detection system is configured to activate the ventilation system and terminate charge and discharge of the at least one battery in response to detecting that the concentration of the gas meets or exceeds the threshold concentration; and
a smoke and temperature detection system configured to activate a fire suppression system within the container, in response to detecting, subsequent to the detecting that the concentration of the gas meets or exceeds the threshold concentration, a presence of smoke and a temperature that meets or exceeds a threshold temperature.

18. The container of claim 17, wherein the gas detection system is configured to activate the ventilation system by causing the ventilation system to open an economizer damper.

19. The container of claim 17, further comprising an alarm on an exterior of the container, wherein the smoke and temperature detection system is further configured to activate the alarm in response to the detecting both the presence of smoke and the temperature that meets or exceeds the threshold temperature.

20. The container of claim 17, wherein fire suppression system comprises one or more electrically activatable fire suppressant units adapted to spray an ionized potassium fire suppressant.
